(19) United States
(12) Patent Application Publication
(10) Pub. No.: US 2016/0265710 A1
(43) Pub. Date: Sep. 15, 2016

(54) TRANSPORT SYSTEM FOR GOODS

(71) Applicant: Melanie McClelland, Williamson, GA (US)

(72) Inventor: Melanie McClelland, Williamson, GA (US)

(21) Appl. No.: 14/657,648

(22) Filed: Mar. 13, 2015

(51) Int. Cl. F16M 11/04; F16M 13/00

(52) U.S. Cl. CPC F16M 11/04; F16M 13/00

(57) ABSTRACT

Implementations of a transport system are provided. In some implementations, the transport system comprises a platform having a plurality of holes extending through the platform. The transport system further comprises a plurality of stops configured to be inserted into the holes in the platform. The transport system further comprises a plurality of blocks where each block has at least one hole extending through the block and configured to receive a stop. Implementations of the transport system may be used to transport large cakes.

### TECHNICAL FIELD

This disclosure relates to implementations of a transport system.

### BACKGROUND

Transporting large unsecured items, particularly delicate items such as cakes, in a vehicle from one location to another can be a challenge. If these items are not properly secured, they can slide or tilt as the vehicle traverses to its destination. For unstable items such as cakes, movement can destroy the item.

### BRIEF DESCRIPTION OF THE DRAWINGS

FIG. 1 illustrates an implementation of an example transport system according to the principles of the present disclosure.

FIG. 2 illustrates a side view of an implementation of an example platform of a transport system according to the principles of the present disclosure.

FIG. 3 illustrates a method of transporting a large cake using a transport system according to the principles of the present disclosure.

### DETAILED DESCRIPTION

Implementations of a transport system are provided. In some implementations, the transport system comprises a platform having a plurality of holes extending through the platform. The transport system further comprises a plurality of stops configured to be inserted into the holes in the platform. The transport system further comprises a plurality of blocks where each block has at least one hole extending through the block and configured to receive a stop.

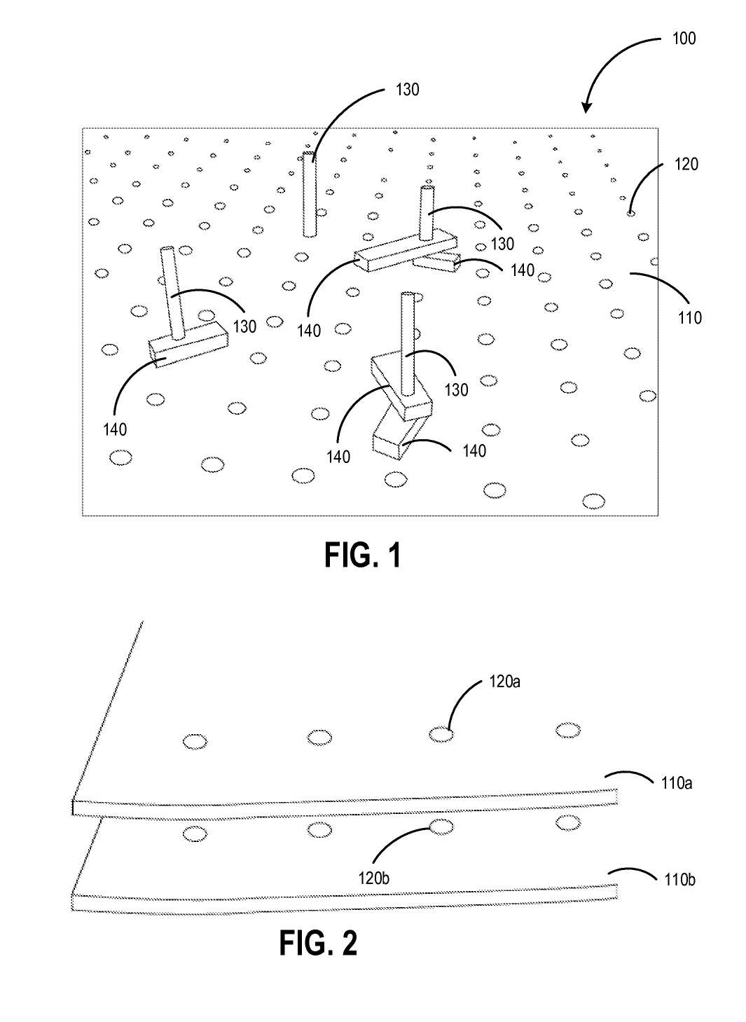

FIG. 1 illustrates an implementation of an example transport system 100 according to the principles of the present disclosure. In some implementations, the transport system 100 comprises a platform 110 having a plurality of holes 120 extending through the platform, a plurality of stops 130 configured to be inserted into the holes 120, and a plurality of blocks 140 where each block has at least one hole extending through the block and configured to receive a stop 130.

In some implementations, the platform 110 is configured to be placed on a flat surface inside a vehicle. In some implementations, the platform 110 is configured such that the platform has no horizontal movement when placed on a flat surface inside a vehicle. In some implementations, the platform 110 can be custom configured to securely fit within a space of a vehicle such that the platform does not move when the vehicle is in motion, accelerates, decelerates, or stops.

As shown in FIG. 2, in some implementations, the platform 110 may comprise a first horizontal flat surface 110a on top of a second horizontal flat surface 110b. In some implementations, each surface 110a, b has a plurality of holes 120a, b, respectively, extending through the surface. In some implementations, the holes 120a, b of the horizontal flat surfaces 110a, b are aligned such that a stop 130 inserted into a hole of surface 110a can be inserted to a hole in surfaces 110b. In this way, the stop 130 may be more secure and can handle more force from an item without breaking.

In some implementations, the first horizontal flat surface 110a and second horizontal flat surface 110b may be spaced apart by four inches. In some implementations, the distance may be less or more.

In some implementations, the first horizontal flat surface 110a and second horizontal flat surface 110b may be 0.5″ thick. In some implementations, the thickness may be less or more.

In some implementations, the two horizontal surfaces may be replaced with one flat surface having a desired thickness. In some implementations, the flat surface may be several inches thick. In some implementations, the thickness may be less or more.

In some implementations, the holes 120 on the platform may be arranged in an array. In some implementations, the holes 120 may be an irregular pattern. In some implementations, the holes 120 may be arranged in any other suitable manner. In some implementations, the holes 120 may be circularly. In some implementations, the holes 120 may be any other suitable shape. In some implementations, the holes 120 may have different sizes.

In some implementations, the platform may be made from wood. In some implementations, the platform may be made from plastic. In some implementations, the platform may be made from any suitable material.

In some implementations, a stop 130 may be elongated and configured to extend above the platform when the stop 130 is inserted in a hole. In some implementations, a stop 130 may be 9 to 10 inches in length. In some implementations, the stop 130 may be shorter or longer. In some implementations, a stop 130 may be configured to extend above the platform by 5-6 inches. In some implementations, the distance may be less or more.

In some implementations, the stops 130 may have different lengths. In some implementations, the stops 130 may be cylindrical. In some implementations, the stops 130 may be any other suitable shape.

In some implementations, the stops may be made from wood. In some implementations, the stops may be made from plastic. In some implementations, the stops may be made from any suitable material.

In some implementations, the blocks 140 may be a cuboid. In some implementations, the blocks 140 may be a cube. In some implementations, the blocks 140 may be a rectangular cuboid. In some implementations, the blocks 140 may be any other suitable shape. In some implementations, the blocks 140 may have different shapes. In some implementations, the blocks 140 may have different lengths.

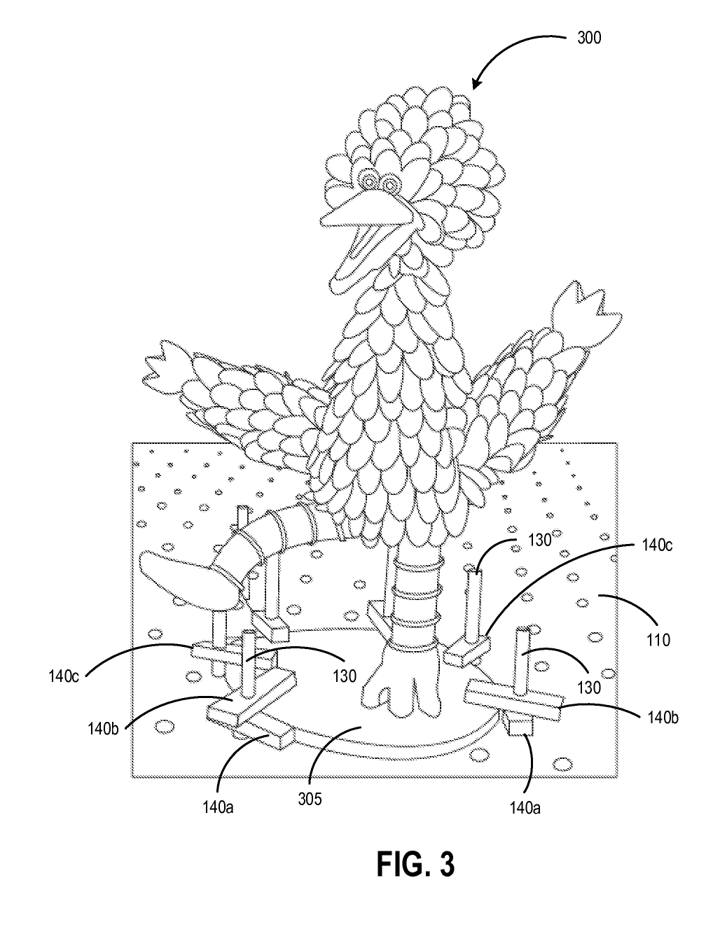

FIG. 3 illustrates a method of transporting a large cake 300 using a transport system according to the principles of the present disclosure. In some implementations, the cake 300 may be secured to a base 305. One of ordinary skill in the art would know how to secure a cake to a base. For example, in some implementations, one or more rods may extend from the base through a portion of the cake. In some implementations, icing may secure the cake to the base. Any method presently known or developed in the future may be used to secure the cake to the base. In some implementations, the base 305 may be circular. In some implementations, the base 305 may be any other suitable shape.

The base 305 may be secured to the transport system (e.g., transport system 100) to help prevent the base 305 from sliding or tilting. In some implementations, to secure the base 305 to the transport system, the base is placed at a desirable location on the platform 110. Next, a plurality of stops (e.g., stops 130) may be inserted into holes next to selected locations along the perimeter of the base 305. In some implementations, stops may be placed in the closest hole at selected locations along the perimeter of the base 305. The stops may help to prevent the base 305 from sliding while the vehicle is in motion, accelerates, decelerates, or stops.

In some implementations, a first block (see, e.g., 140a) may be secured to the platform next to one or more selected locations along the perimeter of the base 305 by inserting a stop next to the selected location in a hole of the first block and sliding the block down the stop until the first block rests on the platform. In this way, the first block also may help to prevent the base 305 from sliding.

In some implementations, the first blocks may be positioned around the base 305 and then the stops may be inserted into the blocks and the platform.

In some implementations, a second block (see, e.g., 140b) may be placed on top of one or more of the first blocks and rotated such that a portion of the second block extends over the top of the base 305. In some implementations, the second block may rest on top of the base 305. The second block(s) may help to prevent tipping of the base 305.

In some implementations, a stop at one or more selected locations along the perimeter of the base 305 may be inserted into a hole of a third block (see, e.g., 140c). The third block may then be slid down the stop and rotated such that a portion of the third block extends over the top of the base 305. In some implementations, the third block may rest on top of the base 305. In this way, the third block(s) also may help to prevent tipping of the base 305.

In some implementations, a plurality of cakes may be secured to a transport system according to the principles of the present disclosure. In some implementations, each cake may be secured to a transport system as discussed above.

In some implementations, the blocks 140 may have different lengths to accommodate various sizes or shapes of the base for stability of base.

Implementations of the transport system of the present disclosure also may be used to transport other items such as groceries, food (e.g. potluck dishes), liquids that need to remain upright and stable (milk, paint, bleach, cleaners, large size soda bottles, etc.), spherical items that roll around (e.g., sports balls), animal crates, flower arrangements or potted plants, fragile glassware (e.g., vases, bowls, bottles, etc.), large framed pictures, electronics, science projects, or other unsecured items.

Implementations of the transport system may be used to transport a variety of categories of items and the stops can be used to serve as a buffer between the different items. For example, the stops can buffer the heavy items from the fragile items.

In some implementations, a plurality of stops may be inserted into holes around one or more unsecured items. For items that are stacked (e.g. boxes), one or more blocks may be placed at one or more locations along the length of the stop to help secure the unsecured items.

In some implementations, the platform, stops, and block may be made from steel or other metal to transport extremely large items (e.g., barrels, heavy equipment, large animals, building components, etc.) on planes, ships, trains, trucks, etc.

Reference throughout this specification to “an embodiment” or “an implementation” or words of similar import means that a particular described feature, structure, or characteristic is included in at least one embodiment of the present invention. Thus, the phrase “in an embodiment” or “an implementation” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A transport system comprising:
platform having a plurality of holes extending through the platform;
a plurality of elongated stops configured to be inserted into the holes; and
a plurality of blocks where each block has at least one hole extending through the block and configured to receive an elongated stop.

2. The transport system of claim 1 wherein the platform comprises a first horizontal surface on top of a second horizontal surface wherein each surface has a plurality of holes extending through the first horizontal surface and the second horizontal surface and wherein the holes of the first horizontal surfaces are aligned with the holes of the second horizontal surface.

3. The transport system of claim 1 wherein the holes on the platform are arranged in an array.

4. A method of transporting a cake using the article of claim 1, the method comprising:
securing a cake to a base;
placing the base at a location on the platform;
inserting a stop into a hole on the platform next to selected locations along the perimeter of the base; and
securing a first block on the platform next to one or more of the selected locations along the perimeter of the base by inserting a stop in the hole of the first block.

5. The method of claim 4 wherein inserting a stop into a hole on the platform next to selected locations along the perimeter of the base comprises inserting a stop into the closest hole at the selected locations along the perimeter of the base.

6. The method of claim 4 further comprising placing a second block on top of one or more of the first blocks and rotating each of the second blocks such that a portion of the second block extends over the top of the base.

7. The method of claim 4 further comprising sliding a third block down one or more of the stops inserted into the platform and rotating the third block such that a portion of the third block extends over the top of the base.

8. A method of transporting a cake using the article of claim 1, the method comprising:
securing a cake to a base;
placing the base at a location on the platform;
inserting a stop into a hole on the platform next to selected locations along the perimeter of the base; and
sliding a block down one or more of the stops inserted into the platform and rotating the block such that a portion of the block extends over the top of the base.
